(19) United States
(12) Patent Application Publication
(10) Pub. No.: US 2023/0236567 A1
(43) Pub. Date: Jul. 27, 2023

(54) POST-PROCESSOR, MACHINING PROGRAM GENERATION METHOD, CNC MACHINING SYSTEM, AND PROGRAM FOR GENERATING MACHINING PROGRAM

(71) Applicant: FANUC CORPORATION, Minamitsuru-gun, Yamanashi (JP)

(72) Inventors: Kiwamu SAITOU, Yamanashi (JP); Osamu HANAOKA, Yamanashi (JP)

(21) Appl. No.: 17/928,711

(22) PCT Filed: Jun. 28, 2021
(86) PCT No.: PCT/JP2021/024326

§ 371 Date: Nov. 30, 2022

(30) Foreign Application Priority Data
Jul. 3, 2020 (JP) 2020-115870

(51) Int. Cl. G05B 19/4069; G05B 19/4097

(52) U.S. Cl. CPC G05B 19/4069; G05B 19/4097

(57) ABSTRACT

In the present invention, a usage function is selected on the basis of information on a CNC device, and a machining program is generated. A post-processor comprises: a machining command input unit into which a machining command is inputted; a CNC information acquisition unit for acquiring option information of the CNC device or information pertaining to specifications thereof; a machining target input unit where machining target information is inputted; an available function determination unit for determining a function available for machining on the basis of the option information or the information pertaining to specifications; a machining program generation unit for generating at least one machining program where at least one function that has been determined to be available is used, or where a function is not used, on the basis of the machining command; a machining simulation unit for simulating a machining result on the basis of the machining program; a machining simulation result assessment unit for assessing a machining simulation result in accordance with a machining target; and a machining program output unit for selecting and outputting a machining program on the basis of the assessment of the machining simulation result.

### TECHNICAL FIELD

The present invention pertains to a post-processor, a machining program generation method, a CNC machining system, and a machining program generation program.

### BACKGROUND ART

In a machine tool, which is controlled by a computer numerical control device (CNC device) and moves a tool or a table for manufacturing a machined article (workpiece) to thereby manufacture the workpiece, an operation by the machine is imparted by a machining program (G code, etc.). However, because machining programs differ by machine manufacturer or options for a machine, a CAM (Computer-Aided Manufacturing) device outputs CL (Cutter location) data which is a machining command that that is independent of a type of machine, and the CL data is converted by a post-processor into a machining program that corresponds to an individual machine. Accordingly, whether it is possible to generate a machining program that uses a CNC function depends on the performance of the post-processor.

Patent Document 1 describes a method in which a CNC device calls a control sub-program in order for the CNC device to cause a machine tool to execute a specific machining step that is to be executed, such as finishing or roughing. Specifically, Patent Document 1 indicates that availability information for designating a control sub-program for a specific machining step that is to be executed is read in a control device (CNC device). Patent Document 1 indicates that, in a case where, for a machining step that is to be executed, a control sub-program belonging to the machining step is available, a control sub-program call request for calling the control sub-program belonging to the machining step is generated as a control command, based on available control sub-programs and operation information.

Patent Document 2 describes a method for avoiding an error at a time of a machining process due to a mismatch between a configuration for a machine tool used when simulating a partial program and an actual configuration for the machine tool at a time of an actual machining process. Specifically, Patent Document 2 indicates that a machining process for a machine tool can be controlled by the partial program, a current configuration for the machine tool is obtained, a comparison is made between the current configuration and a simulation configuration that is for the machine tool and is stored within the partial program, and a warning is generated when there is a mismatch between the current configuration and the simulation configuration.
Patent Document 1: Japanese Unexamined Patent Application, Publication No. 2010-123122
Patent Document 2: Japanese Unexamined Patent Application, Publication No. 2009-123209

### DISCLOSURE OF THE INVENTION

### Problems to be Solved by the Invention

In a case where a current post-processor does not cooperate with a CNC device and an update or addition of an option is performed for the CNC device, it is not possible to use an added function if the post-processor is not updated separately from the CNC device. In addition, there are cases where a user does not understand functions for a CNC device and a useful function is not selected.

Accordingly, there is a desire for a post-processor to reference information regarding a CNC device to thereby generate a machining program by selecting a usage function based on the information regarding the CNC device. There is also a desire for the post-processor to predict a machining result in a machining simulator and thereby output a machining program optimal for a machining target.

### Means for Solving the Problems

(1) A first aspect according to the present disclosure is a post-processor that includes: a machining command input unit configured to receive input of a machining command that is independent of a type of machine; a CNC information acquisition unit configured to communicate with a CNC device and acquire option information regarding the CNC device or information pertaining to a specification for the CNC device; a machining target input unit configured to receive input of machining-target information pertaining to a machining target; an available function determination unit configured to determine, based on the option information regarding the CNC device or the information pertaining to the specification for the CNC device acquired by the CNC information acquisition unit, a function available for machining; a machining program generation unit configured to, based on the machining command, generate at least one machining program that uses, or does not use, at least one function determined to be available by the available function determination unit; a machining simulation unit configured to simulate a machining result based on the at least one machining program generated by the machining program generation unit; a machining simulation result evaluation unit configured to, in accordance with the machining target, evaluate a machining simulation result outputted from the machining simulation unit; and a machining program output unit configured to, based on an evaluation regarding the machining simulation result, select and output a machining program to be used in machining.

(2) A second aspect according to the present disclosure is a CNC machining system provided with: the post-processor according to the abovementioned (1); and a CNC machine that has a CNC device connected to the post-processor and, based on a machining program outputted from the post-processor, performs CNC machining of a workpiece.

(3) A third aspect according to the present disclosure is a machining program generation method for a post-processor, the method including: receiving input of a machining command that is independent of a type of machine; communicating with a CNC device and acquiring option information regarding the CNC device or information pertaining to a specification for the CNC device; receiving input of machining-target information pertaining to a machining target; determining, based on the acquired option information regarding the CNC device or the information pertaining to the specification for the CNC device, a function that is available for machining; based on the machining command, generating at least one machining program that uses, or does not use, at least one function determined to be available; performing a machining simulation for a machining result based on a generated machining program; evaluating a result of the machining simulation in accordance with the machining target; and based on an evaluation regarding the machining simulation result, selecting and outputting a machining program to be used in machining.

(4) A fourth aspect according to the present disclosure is a machining program generation program that causes a computer that corresponds to a post-processor to execute: processing for communicating with a CNC device and acquiring option information regarding the CNC device or information pertaining to a specification for the CNC device; processing for determining, based on the acquired option information regarding the CNC device or the information pertaining to the specification for the CNC device, a function that is available for machining; processing for, based on a machining command that is independent of a type of machine, generating at least one machining program that uses, or does not use, at least one function determined to be available; processing for performing a machining simulation for a machining result based on a generated machining program; processing for evaluating a result of the machining simulation in accordance with an inputted machining target; and processing for, based on an evaluation regarding the machining simulation result, selecting and outputting a machining program to be used in machining.

### Effects of the Invention

By virtue of each aspect according to the present disclosure, it is possible for a post-processor to reference information regarding a CNC device to thereby generate a machining program by selecting a usage function based on the information regarding the CNC device. It is also possible for the post-processor to predict a machining result in a machining simulator and thereby output a machining program optimal for a machining target.

### BRIEF DESCRIPTION OF THE DRAWINGS

FIG. 1 is a block view that illustrates an example of a configuration for a CNC machining system that includes a post-processor according to a first embodiment of the present disclosure;

FIG. 2 is a block view that illustrates an example of a configuration for the post-processor according to the first embodiment of the present disclosure;

FIG. 3 is a view that illustrates an example of information pertaining to CNC functions for a CNC machine tool;

FIG. 4 is a perspective view that illustrates a workpiece resulting from providing a cylinder on a rectangular cuboid;

FIG. 5 is a view that illustrates a workpiece in order to describe a geometric tolerance and a target dimension between specific elements in a target shape;

FIG. 6 is a view that illustrates a tool path for a case of faithfully moving with respect to a command path, and a tool path resulting from performing smoothing such that the command path becomes smooth;

FIG. 7 is a flow chart that illustrates operation by the post-processor;

FIG. 8 is a block view that illustrate an example of a configuration for a post-processor according to a second embodiment of the present disclosure; and

FIG. 9 is a view that illustrates an operation by a machining simulation unit that uses a material shape before machining to obtain a post-machining shape.

### PREFERRED MODE FOR CARRYING OUT THE INVENTION

With reference to the drawings, description is given below regarding details of embodiments of the present invention.

### First Embodiment

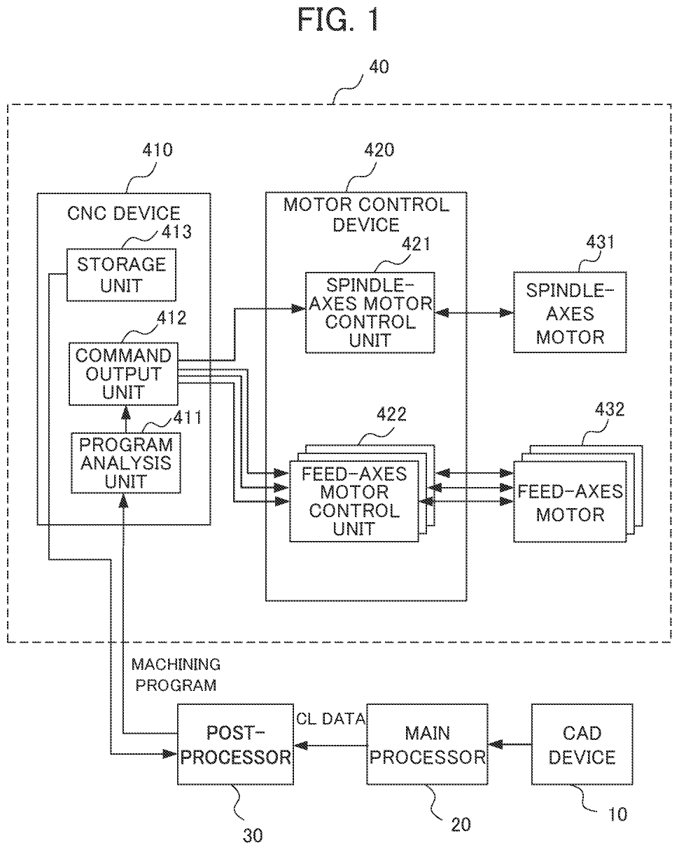

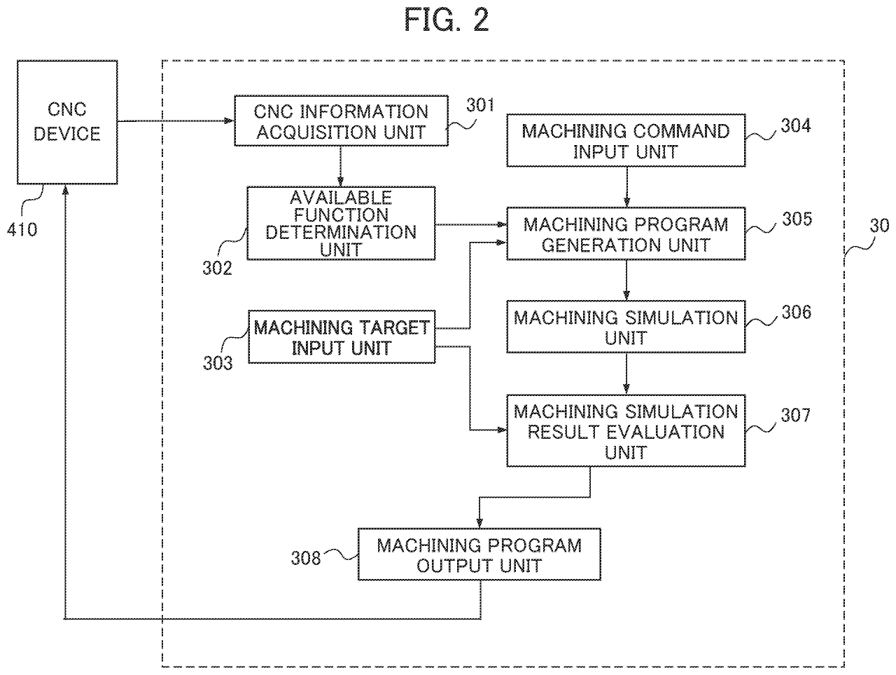

Firstly, description is given regarding a configuration for a CNC (Computerized Numerical Control) machining system that includes a post-processor, according to the first embodiment of the present disclosure. FIG. 1 is a block view that illustrate an example of a configuration for the CNC machining system that includes the post-processor according to the first embodiment of the present disclosure. FIG. 2 is a block view that illustrate an example of a configuration for the post-processor according to the first embodiment of the present disclosure. As illustrated in FIG. 1, the CNC machining system is provided with a CAD (computer-aided design) device 10, a main processor 20, a post-processor 30, and a CNC machine tool 40. The CNC machine tool 40 is provided with a CNC device 410, a motor control device 420, a spindle-axis motor 431, and feed-axis motors 432. In addition to the spindle-axis motor 431 and the feed-axis motors 432, the CNC machine tool 40 is provided with members necessary for machining, but only the spindle-axis motor 431 and the feed-axis motors 432 are illustrated in FIG. 1.

The CAD device 10 uses a CPU (Central Processing Unit) to cause CAD software for performing drafting on a screen of the computer to operate. A workpiece is drafted in two-dimensional CAD or three-dimensional CAD. In a case of using two-dimensional CAD, a front view, a top surface view, a side surface view, etc. for the workpiece are created in a plane for X and Y. In a case of using three-dimensional CAD, a three-dimensional image for the workpiece is created in a three-dimensional space for X, Y, and Z.

Based on CAD data, the main processor 20 sets a motion for a tool or a machine tool so that a machining shape can be obtained, and converts the motion to CL (cutter location) data. The post-processor 30 generates a machining program (NC data) based on the CL data created by the main processor 20. The post-processor 30 is directly or indirectly communicably connected to the CNC device 410 by wire or wirelessly, and refers to information in the CNC device 410 to generate a machining program. A detailed configuration for the post-processor 30 is described below.

Even if the main processor 20 and the post-processor 30 are separately provided, the main processor 20 and the post-processor 30 may be configured integrally as a CAM device. For the main processor 20 and the post-processor 30, it may be that a CPU in a computer is used to cause each of main processor software that causes operation as the main processor 20 and post-processor software that causes operation as the post-processor 30 to operate and thereby cause the main processor software and the post-processor software to function as the main processor 20 and the post-processor 30. It may be that these two items of software are caused to operate on the same computer or are caused to operate on different computers.

Note that it may be that the post-processor 30, the post-processor 30 and the main processor 20, or the post-processor 30, the main processor 20, and the CAD device 10 are included in the CNC machine tool 40.

The CNC machine tool 40 is a three-axis machine that performs CNC machining based on a machining program, for example. Regarding a three-axis machine, the CNC device 410 controls the motor control device 420 based on the machining program, and the motor control device 420 drives the spindle-axis motor 431 and the feed-axis motors 432 to thereby perform machining. The CNC machine tool 40 is not limited to a three-axis machine, and may be a five-axis machine, for example.

The CNC device 410 is provided with a program analysis unit 411, a command output unit 412, and a storage unit 413.

From a machining program (NC data) created by the post-processor 30, the program analysis unit 411 sequentially reads out and analyzes a block that includes a command regarding movement of the X axis, the Y axis, and the Z axis as well as a command regarding rotation by the spindle-axis, calculates, based on an analysis result, command data that commands movement in the X axis, Y axis, and Z axis as well as rotation by the spindle-axis, and outputs the command data to the command output unit 412.

Based on the command data outputted from the program analysis unit 411, the command output unit 412 calculates a speed for each shaft, and outputs data based on a calculation result to a spindle-axis motor control unit 421 and three feed-axis motor control units 422 for the X axis, Y axis, and Z axis, which are in the motor control device 420.

The storage unit 413 stores parameter information for the CNC device 410, option information regarding the CNC device 410, and information pertaining to a specification for the CNC device 410. The information stored by the storage unit 413 may be one or two items of information from among the parameter information for the CNC device 410, the option information regarding the CNC device 410, and the information pertaining to the specification for the CNC device 410. The parameter information for the CNC device 410 is, for example, at least one parameter from among a parameter pertaining to a shaft configuration and a movable range for each shaft, a parameter such as a time constant used to control a speed, an acceleration, and a jerk for each shaft, and a parameter such as allowable position error which is used to control a position for each shaft. Option information regarding the CNC device 410 is, for example, information pertaining to a CNC function that is available in the CNC device 410. Information pertaining to a CNC function that is available in the CNC device 410 includes the presence or absence of a CNC function that is available in the CNC device 410 and, if a CNC function is present, details regarding the CNC function. Information pertaining to a specification for the CNC device 410 is, for example, information pertaining to the manufacturer and model of the CNC device 410, and/or information pertaining to a software version.

The motor control device 420 is provided with the spindle-axis motor control unit 421 and the feed-axis motor control units 422. Based on an output from the command output unit 412, the spindle-axis motor control unit 421 uses a feedback value for a rotation position for the spindle-axis motor 431 to control a rotation operation by the spindle-axis motor 431 in accordance with typical feedback control. Based on the output from the command output unit 412, the three feed-axis motor control units 422 for the X axis, Y axis, and Z axis use feedback values for feed positions for the three feed-axis motors 432 for the X axis, the Y axis, and the Z axis to control a feeding operation by the three feed-axis motors 432. An internal configuration for the spindle-axis motor control unit 421 and the three feed-axis motor control units 422 is well-known to a person skilled in the art, and thus detailed description and illustration thereof is omitted.

The spindle-axis motor 431 causes a tool such as a ball end mill to rotate. The feed-axis motors 432 include three motors for the X axis direction, the Y axis direction, and the Z axis direction. The motors for the X axis direction and the Y axis direction cause, via ball screws, etc., a table on which a substrate for manufacturing a workpiece has been placed to move linearly in the X axis direction and the Y axis direction, respectively. The motor for the Z axis direction causes the tool or the table to move linearly in the Z axis direction. Note that a configuration for a three-axis machine is not limited to this configuration. For example, it may be that the tool is fixed and the feed-axis motors 432 cause the table to move linearly in the X axis direction, the Y axis direction, and the Z axis direction, or the table is fixed and the feed-axis motors 432 cause the tool to move linearly in the X axis direction, the Y axis direction, and the Z axis direction. Linear motors may be used for the motors for the X axis direction, the Y axis direction, and the Z axis direction.

Description is given above regarding a configuration for a CNC machining system. Next, FIG. 2 is used to give a description in further detail regarding the post-processor 30.

<Post-Processor 30>

As illustrated in FIG. 2, the post-processor 30 is provided with a CNC information acquisition unit 301, an available function determination unit 302, a machining target input unit 303, a machining command input unit 304, a machining program generation unit 305, a machining simulation unit 306, a machining simulation result evaluation unit 307, and a machining program output unit 308. The post-processor 30 may be incorporated in the CNC device 410.

The CNC information acquisition unit 301 communicates with the CNC device 410 to acquire from the storage unit 413, and output to the available function determination unit 302, at least one of the option information regarding the CNC device 410 and the information pertaining to the specification for the CNC device 410. In addition, the CNC information acquisition unit 301 may acquire a parameter regarding the CNC device 410 from the storage unit 413 and output the parameter to one or both of the available function determination unit 302 and the machining program generation unit 305. Note that option information regarding the CNC device 410, information pertaining to the specification for the CNC device 410, and a parameter for the CNC device 410 may be generically referred to as “CNC information”.

Based on the option information regarding the CNC device 410 or the information pertaining to the specification for the CNC device 410 acquired by the CNC information acquisition unit 301, the available function determination unit 302 determines a CNC function that is available in the CNC device 410, and outputs the CNC function to the machining program generation unit 305. In a case where the CNC information acquisition unit 301 has acquired, as option information, information pertaining to a CNC function that is available in the CNC device 410, the available function determination unit 302 determines the presence or absence of a CNC function that is available in the CNC device 410, and, in the case where a CNC function is present, extracts the CNC function. For example, there are a smoothing function and a function for high-speed machining as CNC functions that are extracted.

Even without using option information, the available function determination unit 302 can use the information pertaining to the specification for the CNC device 410 to thereby determine a CNC function that is available in the CNC device 410. Specifically, the available function determination unit 302 can use, for example, information pertaining to the manufacturer and model for the CNC device 410 and/or information pertaining to a software version as information pertaining to the specification for the CNC device 410 to refer to a list of functions for the CNC device 410 stored by itself and thereby determine whether a smoothing function FA and a function for high-speed machining are CNC functions that are available in the CNC device 410.

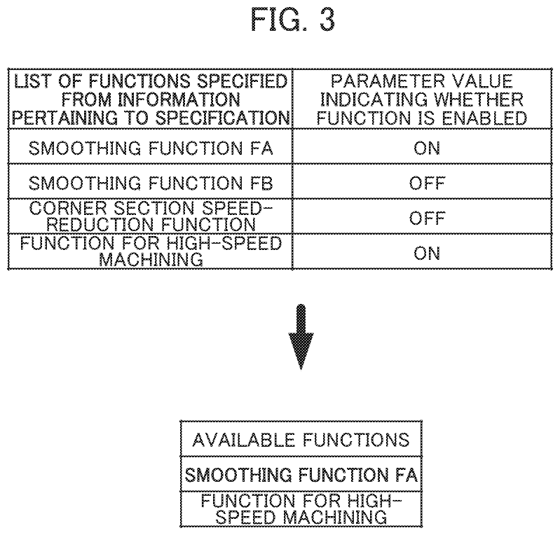

In addition, the available function determination unit 302 can use the information pertaining to the specification for the CNC device 410 to refer to a list of functions for the CNC device 410 stored by itself and thereby specify a plurality of functions that can be used in the CNC device 410, and refer to a NC parameter that is included in parameters for the CNC device 410 and indicates whether a plurality of functions for the CNC device 410 are each enabled to thereby determine a CNC function that is available in the CNC device 410. Specifically, the available function determination unit 302 can use, for example, information pertaining to the manufacturer and model for the CNC device 410 and/or information pertaining to a software version as information pertaining to the specification for the CNC device 410 to refer to a list of functions for the CNC device 410 stored by itself and thereby specify the smoothing function FA, a smoothing function FB, a corner section speed-reduction function, and a function for high-speed machining, which are illustrated in FIG. 3, as functions that can be used in the CNC device 410. Next, the available function determination unit 302 can refer to an NC parameter that is included in parameters for the CNC device 410 and indicates whether a function for the CNC device 410 is enabled to determine whether the smoothing function FA and the function for high-speed machining are CNC functions that are available in the CNC device 410. In FIG. 3, a parameter indicating that a function is enabled is ON for the smoothing function FA and the function for high-speed machining and is OFF for other functions. The available function determination unit 302 can select the smoothing function FA and the function for high-speed machining as CNC functions that are available in the CNC device 410.

The machining target input unit 303 outputs a machining target, which is inputted by a user and is for when performing machining, to the machining program generation unit 305 and the machining simulation result evaluation unit 307. The machining target, for example, may include at least one of an amount of time required for machining, a machining accuracy, a machining quality, and a combination resulting from adding priorities to at least two of these. The amount of time required for machining is a shortest machining amount of time or a machining target amount of time, for example. The machining accuracy is a target shape and a dimensional difference or a target shape and a geometric tolerance, for example. The machining quality is a tolerance value for surface roughness, for example. In a case where there is a plurality of machining targets, it may be that a target that must be satisfied and a target that does not need to be satisfied are set. However, a priority for the target that does not need to be satisfied is set lower than a priority for the target that must be satisfied. In a case where the machining accuracy or the machining quality are included in a machining target, a position on a target shape at which the target is to be employed may also be inputted.

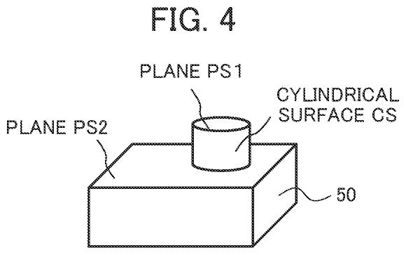

Table 1 indicates respective values, priorities and locations at which to apply machining for a machining amount of time, a machining accuracy, and a machining quality, which are to be machining targets, in a case of manufacturing the workpiece that is illustrated in FIG. 4 and is provided with a cylinder on a rectangular cuboid.

TABLE 1

| Machining | | | Application |
|---|---|---|---|
| target | Value | Priority | location |
| Machining | Shortest | Third | |
| amount of | | | |
| time | | | |
| Machining | D 20 ± 0.01 mm | First, | Cylindrical |
| accuracy | | essential | surface CS |
| Machining | Less than Ra 3.2 | Second | Plane PS1 and |
| quality | | essential | plane PS2 |

FIG. 4 is a perspective view that illustrates a workpiece resulting from providing a cylinder on a rectangular cuboid. In FIG. 4, a workpiece 50 is provided with a cylinder having a plane PS1 and a cylindrical surface CS, on a plane PS2 belonging to a rectangular cuboid. In Table 1, a machining amount of time, a machining accuracy, and a machining quality are set as machining targets. In addition, in Table 1, shortest, a diameter D=20±0.01 mm for the cylindrical surface CS, and a surface roughness Ra of less than 3.2 are respectively set as values for the machining amount of time, machining accuracy, and machining quality; priorities are set in the order of machining accuracy, machining quality, and machining amount of time; and that the settings regarding the order for the priorities for the machining accuracy and machining quality are essential is set. In addition, in Table 1, the machining accuracy is set for the cylindrical surface CS and the machining quality is set for the plane PS1 and the plane PS2.

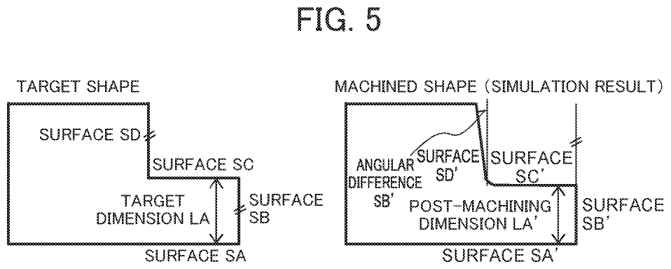

It is possible to designate the machining accuracy, which is a machining target, based on the following information, for example.
A target dimension between specific elements in a target shape (for example, a target distance between a surface SA and a surface SC in FIG. 5)
A geometric tolerance between specific elements in the target shape (for example, target parallelism between a surface SB and a surface SD in FIG. 5)

More specifically, in a case of employing the distance between the surface SA and the surface SC as a target dimension LA and evaluating a dimensional difference between the target dimension LA and a post-machining dimension as illustrated in FIG. 5, a surface SA′ and a surface SC′ that correspond to the surface SA and the surface SC and are for a machined shape are determined. As a method of determining the surface SA′ and the surface SC′, there is a method of setting the surface SA′ to a surface on the machined shape that is closest to the position and orientation of the surface SA on the target shape. It is possible to similarly determine the surface SC′. In FIG. 5, the distance between the surface SA′ and the surface SC′ is employed as a post-machining dimension LA′, and the difference between the target dimension LA and the post-machining dimension LA′ is set to the dimensional difference.

In addition, in a case of evaluating the parallelism between the surface SB and the surface SD as a geometric tolerance, a surface SB′ and a surface SD′ are similarly determined, and the angle between the surface SB′ and the surface SD′ is calculated as a post-machining geometric tolerance.

In addition, for example, it is possible to designate a tolerance value, for example surface roughness, etc. for the machining quality regarding a machining target. Note that, as described in, for example, “Simulation of Surface roughness and profile in high-speed end milling”, Ki Yong Lee, Myeong Chang Kang, Yung Ho Jeong, Deuk Woo Lee, Jeong Suk Kim, Journal of Materials Processing Technology 113 (2001) 410-415, a method of using a simulation to calculate a surface roughness is publicly known to a person skilled in the art, and a detailed description thereof is omitted.

The machining command input unit 304 outputs, to the machining program generation unit 305, an inputted machining command that is independent of a type of machine. Here, a CL file (Cutter Location file) is given as an example of a machining command that is independent of a type of machine. With the configuration illustrated in FIG. 1, a CL file is inputted from the main processor 20.

The machining program generation unit 305 generates one or more machining programs based on the machining command. At this time, the machining program generation unit 305 generates a machining program using at least one function determined to be available by the available function determination unit 302, or without using a function. In the example described above, functions determined to be available by the available function determination unit 302 are the smoothing function FA and the function for high-speed machining, and thus the available function determination unit 302 can generate the following machining programs (a) through (d).

(a) A machining program that does not use functions
(b) A machining program that used the smoothing function FA
(c) A machining program that used the function for high-speed machining
(d) A machining program that used the smoothing function FA and the function for high-speed machining

However, the machining program generation unit 305 does not need to create all of the machining programs (a) through (d). For example, the following cases (A) and (B) can be given as cases in which any one or more program is created, instead of all of the machining programs (a) through (d).

(A) A case in which the machining program generation unit 305 can refer to the information pertaining to the specification for the CNC device 410 and grasps a combination of functions that cannot be put to combined use. For example, in a case where smoothing function FA and the function for high-speed machining cannot be put to combined use, it may be that the machining program generation unit 305 generates the machining programs (a) through (c) without generating the machining program (d).
(B) A case in which the machining program generation unit 305 can refer to the information pertaining to the specification for the CNC device 410 and later-described machining-target information, and grasps an effect of each CNC function in advance. For example, in a case where a machining target is only “shortest machining amount of time” and the machining program generation unit 305 grasps that an effect of the function for high-speed machining is the shortening of the machining amount of time, it may be that the machining program generation unit 305 creates only the machining programs (c) and (d).

The machining program generation unit 305 may generate a machining program that includes a command that changes one or more values for a parameter for the CNC device 410 that was acquired by the CNC information acquisition unit 301. For example, the machining program generation unit 305 can include a command for performing a change such that one or more values for parameters for the CNC device 410 are mutually different, among two or more machining programs from among the machining programs (a) through (d). Here, among parameters for the CNC device 410, for example, there are the following as parameters for which it is possible to change the value of the parameter in accordance with a command.
A parameter such as a time constant that is used to control the speed, acceleration, and jerk for each shaft
A parameter such as an allowable position error that is used to control the position of each shaft

By setting, as appropriate, values for the abovementioned parameters, it is possible to determine that a machine will satisfy characteristics such as the following when machining.
In a case of emphasizing speed, it is possible to set a parameter value such that the machining speed becomes high speed.
In a case of emphasizing accuracy, it is possible to set a parameter value such that error from a commanded route becomes small.
In a case of emphasizing smoothness, it is possible to set a parameter value such that the acceleration or jerk for each shaft becomes small.

An example is given below to describe a specific method by which the machining program generation unit 305 determines a parameter value. The CNC device 410 attempts to move a tool on the whole in accordance with a tool path and a command speed that are commanded by a machining program, but an actual tool path and the tool path commanded by the machining program do not necessarily match because the following factors (a) and (b) occur.

(a) For example, in a case where a command speed is fast or in a case where a curve in a commanded route is sharp, when passing the commanded route at the command speed, the acceleration on the curve may become too large and, for example, exceed the performance of a motor that drives a shaft. Furthermore, for example, vibration may occur in such a case.
(b) A tool path is typically written with broken lines and thus, even if a target shape is a smooth curved surface, for example, the command path will be a polygon. Accordingly, there may be deliberate deviation from the command path so that a machining result becomes a smooth curve.

To handle the factor (a), the machining program generation unit 305 can change values for the abovementioned parameters to thereby determine that the machine performs (1a), (2b) or an intermediate operation.

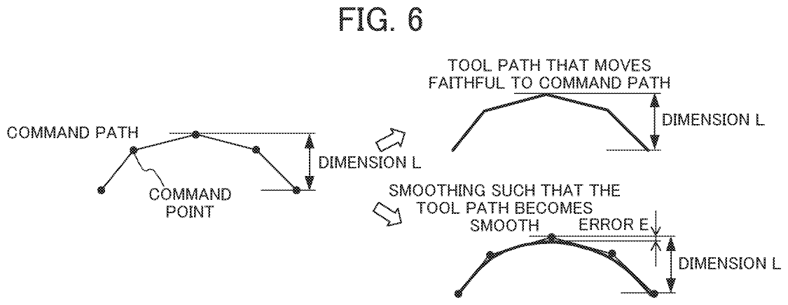

(1a: Emphasizing speed) It is possible to set a parameter value such that, as much as possible, speed does not drop, because it is acceptable even if there is deviation from the commanded route or vibration occurs. As a result, it is possible to shorten the machining amount of time. In contrast, a case where a satisfactory dimensional accuracy does not arise or a case where a machined surface rattles can occur.
(2a: Emphasizing accuracy) It is possible to set a parameter value in order to proceed as with a command path, such that vibration does not occur, because it is acceptable even if speed drops. As a result, it is possible to have good dimensional accuracy and also neatly machine a machined surface. In contrast, a case in which the machining amount of time lengthens can occur. To handle the factor (b), the machining program generation unit 305 can change values for the abovementioned parameters to thereby determine that the machine performs (1b), (2b) or an intermediate operation.
(1b: Emphasizing command path) It is possible to set a parameter value so that movement is performed as with a command path, such that an angle between broken lines does not arise. In contrast, a case where the machined surface will be jagged can occur.
(2b: Emphasizing smoothness) It is possible to perform smoothing by setting a parameter value such that a tool path becomes smooth. In contrast, a case where dimensional accuracy will worsen can occur. FIG. 6 is a view that illustrates a tool path for a case of faithfully moving with respect to a command path, and a tool path resulting from performing smoothing such that the command path becomes smooth. With the tool path for the case of moving faithfully with respect to the command path, a jagged surface (angular surface) will arise, but accuracy for a dimension L will be good. In contrast, with the tool path that results from performing smoothing so as to be smooth, a smooth surface is achieved, but accuracy for the dimension L is not good.

As above, in order for the machine to satisfy characteristics to emphasize speed, emphasize accuracy, or emphasize smoothness as described above, the machining program generation unit 305 may determine values for parameters by combining the abovementioned operations (1a) and (2a) with the abovementioned operations (1b) and (2b), as in Table 2.

TABLE 2

| | |
|---|---|
| Emphasizing | Select (1a) to handle factor (a) |
| speed | The factor (b) is not very important because |
| | position accuracy is poor |
| Emphasizing | Select (2a) to handle factor (a) and select |
| accuracy | (1b) to handle factor (b) |
| Emphasizing | Select (2a) to handle factor (a) and select |
| smoothness | (2b) to handle factor (b) |
| Balance between | Select a parameter in between (1a) and (2a) |
| speed and | to handle the factor (a) |
| accuracy | Select (1b) to handle the factor (b) |

Here, description is simply given regarding an example of stating a command for changing a parameter in a machining program. Regarding commands for changing parameter value in a machining program, there are two types of methods: a command that sets a value to each parameter as indicated in Table 3, and a command that collectively changes parameters relating to an operation to values that were registered in advance as indicated in Table 4.

TABLE 3
Program example 1 Command that changes
value for each parameter

| | |
|---|---|
| G00 X100.0 Y0.0 | |
| G01 Z0.5 | |
| . | |
| . | |
| . | |
| G00 Z100.0 | |
| G10 L52 | ←Command for changing parameter |
| | starts here |
| N1322 P3 R4500 | ← Change value for Z axis for |
| | parameter No. 1322 to 4500 |
| G11 | ←Command for changing parameter ends |
| | here |
| G00 X100.0 Y0.0 | Hereafter, the machine operates in |
| G01 Z0.5 | accordance with settings for after the |
| . | parameter change |
| . | |
| . | |
| G01 X120.0 Y20.0 | |
| . | |
| . | |
| . | |

In Table 3, for a parameter referred to as No. 1322, it is possible to set a different value for each axis, and a number for an axis to change is designated by P. P indicates an axis and, for example, P1 indicates the X axis, P2 indicates an Y axis, and P3 indicates the Z axis.

TABLE 4
Program example 2 Case of changing a plurality of
parameters to values that are registered in advance

| | |
|---|---|
| . | |
| . | |
| . | |
| M31 L6 | ← Command for making a change to a |
| | parameter set for emphasizing speed |
| G00 X100.0 Y0.0 | In the meantime, the accuracy is poor |
| G01 Z0.5 | but movement is at high speed (for |
| . | rough machining) |
| . | |
| . | |
| G01 X120.0 Y20.0 | |
| G00 Z100.0 | |
| X100.0 Y0.0 | |
| M31 L1 | ← Command for making a change to a |
| | parameter set for emphasizing |
| | accuracy |
| G01 Z0.0 | Hereafter, the speed drops but movement |
| . | is with high accuracy (for finishing) |
| . | |
| . | |

There is an advantage in that, in a machining program as described above, a method of inserting a command for changing a parameter value enables operation by a machine to change partway through the program. Accordingly, this method is suitable for a case for changing a machine setting in accordance with the machining program or in a case where it is necessary to cause a machine setting to change during a series of machining as with roughing and finishing. However, in a case of correcting a machine setting, it is necessary to rewrite all corresponding commands. In particular, in a case of desiring to perform machining with the same machine setting for a plurality of programs, a necessity to rewrite commands in all of the programs arises.

Based on each machining program generated by the machining program generation unit 305, the machining simulation unit 306 simulates a machining result, and outputs machining simulation result information. The machining simulation result information, for example, includes information pertaining to a post-machining shape and/or information pertaining to a machining amount of time. A technique for simulating a machining result based on a machining program is known as described in Japanese Patent No. 5149421, for example, and thus detailed description thereof is omitted. Note that, in a case of using information regarding parameters for the CNC device 410 in a machining simulation, the machining simulation unit 306 may refer to information regarding parameters for the CNC device 410 that are already described.

In a case where the machining program generation unit 305 generates a machining program that includes a command for changing one or more parameter value for the CNC device 410, the machining simulation unit 306 can, for at least one machining program generated by the machining program generation unit 305, perform a machining simulation under two or more conditions where parameter values for the CNC device 410 are different. Specifically, in a case where the machining program generation unit 305 has set two or more different conditions for a parameter such as a time constant which is used to control the speed, acceleration, or jerk for each shaft, the machining simulation unit 306 performs a machining simulation for each condition. As a result, for each parameter value for the CNC device 410 used in the machining simulations, the machining simulation unit 306 can output a result of associating the parameter value with a simulation result that was employed.

Based on the machining target outputted from the machining target input unit 303, the machining simulation result evaluation unit 307 evaluates and scores a machining simulation result outputted from the machining simulation unit 306. Specifically, if the machining target is “shortest machining amount of time”, high scores are provided to machining simulation results in an order from the shortest machining amount of time. Note that, in a case where machining targets are provided as a combination of a plurality of targets, higher scores are provided the more that something satisfies a target having a higher priority. In the example illustrated in FIG. 4 and Table 1, firstly accuracy for the cylindrical surface CS is the target having the number one priority, and thus a machining simulation result that satisfies the diameter D of the cylindrical surface CS being 20±0.01 mm is selected. In a case where there is no result that satisfies the target, the highest score is provided to a result for which the diameter D of the cylindrical surface CS is closest to the target, and the evaluation ends. Next, a result satisfying the surface roughness Ra being less than 3.2 for the planes PS1 and PS2, which is the second priority, is selected from among selected machining simulation results. If there is no result that satisfies the target, the highest score is provided to a result closest to the target, and the evaluation ends. Finally, from among selected results, scores are provided in an order from the shortest machining amount of time.

In a case where there is nothing from among machining simulation results that satisfies all of the targets that should necessarily be satisfied, the machining simulation result evaluation unit may output, together with an evaluation result, that there is no machining program that satisfies the targets.

The machining program output unit 308 outputs, to the CNC device 410, a machining program that produced a machining simulation result to which the highest score was added by the machining simulation result evaluation unit 307, as a machining program to use in machining. The CNC device 410 uses the machining program in DNC (direct numerical control operation). In a case where, for each parameter value for the CNC device 410 used in a machining simulation, a simulation is performed for a machining program that employs this parameter value, the machining program output unit 308 may output a result of inserting a command for changing the parameter value in the CNC device 410 to this parameter value into a machining program that was associated with the parameter value and corresponds to a machining simulation result to which the highest score was added by the machining simulation result evaluation unit 307.

In the embodiment described above, the machining command input unit 304 may receive input of a machining command in which machining is expressed as a set of one or more machining steps. As an example of a machining command in which machining is expressed as a set of one or more machining steps, there is a machining command which is described in accordance with a STEP NC data model. Details of such a machining command are described in Japanese Patent No. 66460276, in particular paragraph [0034] and FIG. 4.

In a case where a machining command in which machining is expressed as a set of one or more machining steps is inputted to the machining command input unit 304, the machining target input unit 303, the machining command input unit 304, the machining program generation unit 305, the machining simulation unit 306, the machining simulation result evaluation unit 307, and the machining program output unit 308 perform the following processing. In case where the machining command input unit 304 receives input of a machining command in which machining is expressed as a set of one or more machining steps, the machining program generation unit 305 deciphers the machining command, and decomposes the machining command into the machining steps. Based on the each of the decomposed machining steps, the machining program generation unit 305 generates one or more machining programs having different combinations of NC functions that are used.

A machining target for each machining step may be set forth in machining-target information inputted to the machining target input unit 303. In this case, for each machining step, a machining target corresponding to the machining step is employed. In a case where a machining target is not set forth for each machining step, the same machining target is employed for all machining steps. The machining simulation unit 306 performs a machining simulation for each step, and the machining simulation result evaluation unit 307 evaluates a machining simulation result for each machining step. The machining program output unit 308 selects, for each machining step, a machining program that produced a machining simulation result having the highest evaluation, and joins these machining programs in accordance with an order for the machining steps that was described in the machining command to thereby generate a machining program for all of the machining, and outputs a machining program for all of the machining steps.

Description is given above regarding functional blocks included in the post-processor 30. In order to realize these functional blocks, the post-processor 30 is provided with an arithmetic processing device such as a CPU (Central Processing Unit). In addition, the post-processor 30 is also provided with an auxiliary storage device such as an HDD (Hard Disk Drive) that stores application software or various control programs such as an OS (Operating System), or a main storage device such as a RAM (Random-Access Memory) for storing data that is temporarily necessary for the arithmetic processing device to execute a program.

In the post-processor 30, the arithmetic processing device, having read application software or the OS from the auxiliary storage device and deployed the read application software or OS to the main storage device, performs arithmetic processing based on the application software or OS. In addition, based on a corresponding arithmetic result, various types of hardware provided with respective devices are controlled. As a result, functional blocks according to the present embodiment are realized. In other words, the present embodiment can be realized by hardware and software collaborating.

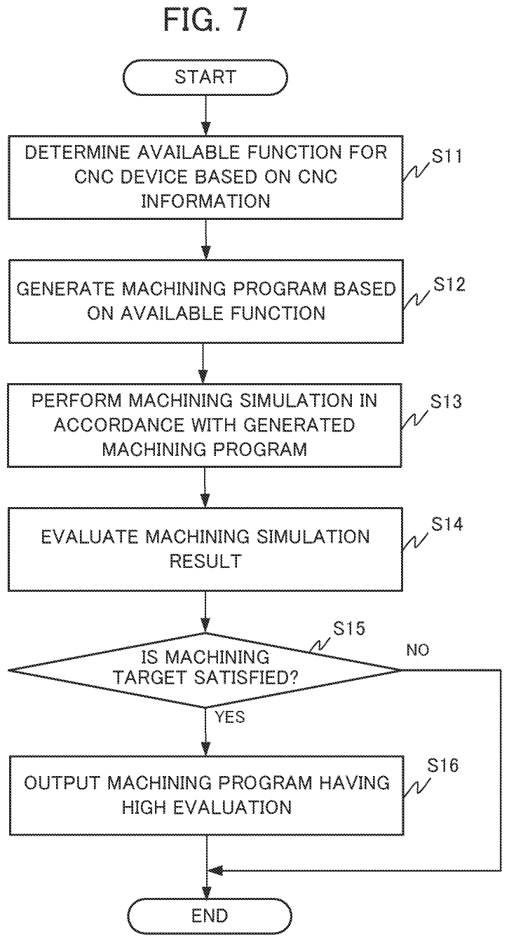

Next, a flow chart is used to give a description regarding operation by the post-processor 30. FIG. 7 is a flow chart that illustrates operation by the post-processor 30. In Step S11, the CNC information acquisition unit 301 acquires CNC information, and the available function determination unit 302 determines an available function for a CNC device based on the CNC information acquired by the CNC information acquisition unit 301.

In Step S12, based on a machining command, the machining program generation unit 305 generates a machining program by selecting, or not selecting, from among functions determined to be available by the available function determination unit 302. In Step S13, based on each machining program generated by the machining program generation unit 305, the machining simulation unit 306 simulates a machining result, and outputs machining simulation result information. The machining simulation result information, for example, includes information pertaining to a post-machining shape and/or information pertaining to a machining amount of time.

In Step S14, based on a machining target outputted from the machining target input unit 303, the machining simulation result evaluation unit 307 evaluates and scores machining simulation results.

In Step S15, the machining simulation result evaluation unit 307 determines whether the machining simulation results satisfy the machining target. In a case where nothing from among the machining simulation results satisfies the machining target, the machining simulation result evaluation unit 307 may output that there is no machining program that satisfies the target together with the evaluation result, and processing ends.

In Step S16, in a case where a machining simulation result satisfies the machining target, the machining program output unit 308 outputs, to the CNC device, a machining program that produced a machining simulation result to which the highest score was added by the machining simulation result evaluation unit 307, as a machining program to use in machining, and processing ends.

By virtue of the first embodiment described above, it is possible for a post-processor to reference information regarding a CNC device to thereby generate a machining program by selecting a usage function based on the information regarding the CNC device. It is also possible for the post-processor to predict a machining result in a machining simulator and thereby output a machining program optimal for a machining target.

### Second Embodiment

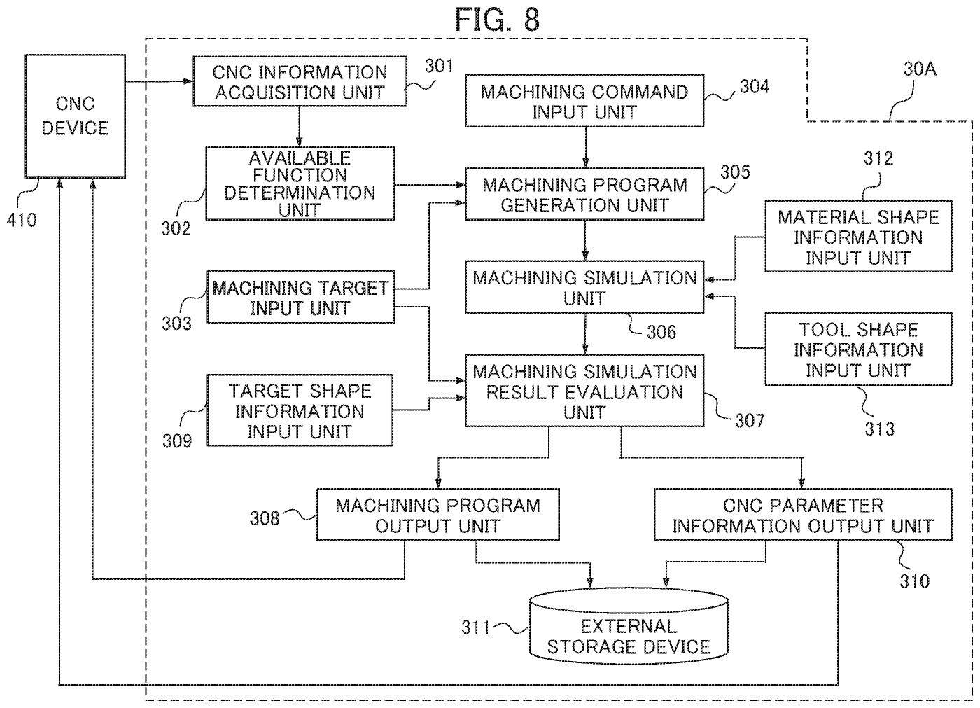

FIG. 8 is a block view that illustrate an example of a configuration for a post-processor according to a second embodiment of the present disclosure. As illustrated in FIG. 8, for a post-processor 30A according to the present embodiment, a CNC parameter information output unit 309, an external storage device 310, a target shape information input unit 311, a material shape information input unit 312, and a tool shape information input unit 313 are added to the post-processor 30 illustrated in FIG. 2. The same reference symbols are added to the same constituent members as those in the post-processor 30 illustrated in FIG. 2, and description thereof is omitted. A configuration of a CNC machining system in the present embodiment is the same as the configuration of the CNC machining system illustrated in FIG. 1 except for that the post-processor 30 illustrated in FIG. 1 is replaced by the post-processor 30A.

In the first embodiment, the machining program output unit 308 outputs a result of inserting, into a machining program that produced a machining simulation result to which the highest score was added by the machining simulation result evaluation unit 307, a command for changing a parameter value in the CNC device 410 to a parameter value that is for the CNC device 410 and was associated with the machining simulation result. In the present embodiment, instead of inserting a command for changing a parameter value in the CNC device 410 into a machining program, the CNC parameter information output unit 309, which outputs parameter information for the CNC device 410, is provided. The CNC parameter information output unit 309 outputs, to the CNC device 410, parameter information that is for the CNC device 410 and includes a group of a parameter value and a number for a parameter in the CNC device 410 used when a machining simulation result to which the highest score has been added by the machining simulation result evaluation unit 307 is produced. The machining program output unit 308 outputs only a machining program that produced the machining simulation result to which the highest score was added by the machining simulation result evaluation unit 307. By virtue of the CNC parameter information output unit 309, parameter information for the CNC device 410 is outputted separately from a machining program. In a method that uses this to change a parameter for a machine, before starting machining, the parameter information for the CNC device 410 is read, and all CNC parameters are collectively changed. Table 5 indicates an example of parameter information for the CNC device 410.

TABLE 5
CNC parameter information

| | |
|---|---|
| . | |
| . | |
| . | |
| N01320 Q1 A1 P500.5 A2 P0.5 A3 P0.5 | ←N: Parameter number |
| N01321 Q1 A1 P-0.5 A2P-400.5 A3 P-300.5 | A: Axis numbers (1: X axis |
| N01322 Q1 A1 P0.0 A2 P0.0 A3 P0.0 | 2: Y axis 3: Z axis) |
| . | P: Parameter value |
| . | |
| . | |

In Table 5, A indicates an axis number, A1, indicates the X axis, A2 indicates the Y axis, and A3 indicates the Z axis. In addition, P in Table 5 indicates a parameter value.

With a method in which the CNC parameter information output unit 309 outputs parameter information for the CNC device 410 separately from a machining program and this is used to change a parameter for a machine, there is an advantage in that, in a case of changing a machine setting, it is sufficient if only the parameter information for the CNC device 410 is corrected and there is no need to correct each program. This method is suitable for a case of desiring only to change the machine setting without changing a machining program, or a case of desiring to cause a plurality of machining programs to operate by the same machine setting. However, it is not possible to change a machine setting partway through machining because parameters are not collectively set before machining.

Parameter information for the CNC device 410 may be outputted to the external storage device 310 as a file instead of being outputted to the CNC device 410. In addition, a machining program may be outputted to the external storage device 310 as a file instead of being outputted to the CNC device 410.

A machining target inputted to the machining target input unit 303 includes a machining accuracy, and there are cases where a machining accuracy is designated by an allowable error with respect to a target shape. There are cases where the machining simulation result evaluation unit 307 needs a comparison between a machined shape predicted by the machining simulation unit 306 and a target shape. The target shape information input unit 311 may be provided for such a case. The target shape information input unit 311 outputs, to the machining simulation result evaluation unit 307, post-machining target shape information that was inputted by a user. The target shape information is CAD data, for example. The CAD data inputted from the CAD device 10 illustrated in FIG. 1.

Even if not CAD data, a post-machining target shape may be any kind of data if three-dimensional representation is possible. Besides CAD data, as examples of data that enables a three-dimensional shape to be represented, there is CSG (Constructive Solid Geometry) data, polyhedral element model data, voxel data, a polygon mesh, and point cloud data. CSG data is information in which a three-dimensional shape is represented as a set of basic shapes. CSG data is, for example, information regarding basic shape types (plane, sphere, cube, cylinder, etc.), dimensions thereof (an outline for a plane, a diameter for a sphere, a length, width, and height for a cube, diameter and length for a cylinder, etc.), a position and orientation thereof, and a state of overlapping (added together, differences, common portions, etc.). Polyhedral element model data is information regarding a target shape that is represented as a set of polyhedrons. Voxel data is information regarding a target shape that is represented as a set of cubes. A polygon mesh is surface information for a target shape, represented as a set of polygons. Point cloud data is surface information for a target shape, represented by a point cloud.

In a case where, in addition to a machining program, information regarding a material shape before machining is necessary in simulation machining by the machining simulation unit 306, the material shape information input unit 312 outputs, to the machining simulation unit 306, information regarding the material shape before machining that was inputted by a user. The material shape before machining is information pertaining to a three-dimensional shape for an object to be cut, for before a machining program is executed. If machining from a block, the material shape before machining is a rectangular cuboid. If machining from a casting, the material shape before machining is the shape of the casting. In a case of performing some kind of machining in a previous step, such as performing a finishing step after rough machining, the material shape before machining is shape information for an object to be cut at the time when the immediately prior step completed. For a format for data for information regarding a material shape before machining, for example, it is possible to use CAD data, which is the same as for target shape information, but any format is sufficient if the format can represent a three-dimensional shape.

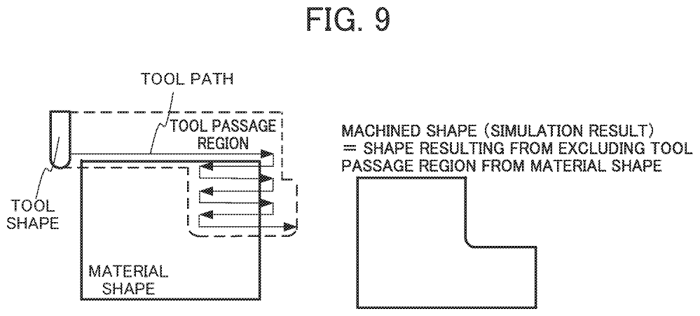

The machining simulation unit 306 calculates a region that is passed through when a tool moves in accordance with a machining program. As illustrated in FIG. 9, this region is a portion that is shaved away by a tool when machining, and thus an object resulting from excluding the region through which the tool passes through from the material shape before machining outputted from the material shape information input unit 312 becomes the post-machining shape. FIG. 9 is a view that illustrates an operation by a machining simulation unit that uses a material shape before machining to obtain a post-machining shape.

In a case where, besides a machining program, information regarding a tool shape for a tool used in machining is necessary in simulation machining by the machining simulation unit 306, the tool shape information input unit 313 outputs, to the machining simulation unit 306, information regarding a tool shape that was inputted by a user.

There is a case in which target shape information, material shape information, and tool shape information is inputted to the post-processor 30A by a user separately from the main processor 20 or the CAD device 10, and a case in which the target shape information, material shape information, and tool shape information is included in CL data outputted by the main processor 20. For example, if a standard for STEP NC stipulated by ISO-14649 is used, it is possible to include all of the information described above in CL data outputted by the main processor 20. In a case where such a machining command is inputted, there is no need to separately input target shape information, material shape information, and tool shape information. In a case such as where target shape information, material shape information, and tool shape information are not included in CL data and CL data only includes information regarding a movement route for a tool, then target shape information, material shape information, and tool shape information are separately inputted to the post-processor.

In the present embodiment, it may be that one or more components from among the CNC parameter information output unit 309, the external storage device 310, the target shape information input unit 311, the material shape information input unit 312, and the tool shape information input unit 313 is selected and provided. In other words, it is possible for the post-processor 30A illustrated in FIG. 8 to have, with respect to the post-processor 30 illustrated in FIG. 1, for example, a configuration in which only the CNC parameter information output unit 309 is added, a configuration in which the CNC parameter information output unit 309 and the external storage device 310 are added, a configuration in which only the target shape information input unit 311 is added, a configuration in which the material shape information input unit 312 or the tool shape information input unit 313 is added, etc.

Description was given above regarding embodiments of the present invention, but some or all of the functions of the post-processors 30 and 30A can be realized by software. However, functions for the post-processors 30 and 30A can be realized by hardware or a combination of software and hardware. Being realized by software means being realized by a computer reading and executing a program. In a case where the post-processors 30 and 30A are configured by hardware, some or all of respective components in the post-processors 30 and 30A, for example, can be configured by an integrated circuit (IC) such as an LSI (Large-Scale Integrated circuit), an ASIC (Application-Specific Integrated Circuit), a gate array, or an FPGA (Field-Programmable Gate Array).

In a case where the post-processors 30 and 30A are realized by software, it is possible to execute, by a program, operation by the post-processors 30 and 30A by storing, in a second storage unit such as a RAM, information necessary for a calculation in accordance with a post processor application which is stored in a first storage unit such as a hard disk device or a ROM and in which is written operations as illustrated in FIG. 7, which are for causing the post-processors 30 and 30A to operate, and by a CPU executing processing. The post processor application can be read into the first storage unit, which is a hard disk, etc., from a medium that can be read by a computer into which the program has been recorded. A computer-readable medium includes various types of tangible storage mediums. A computer-readable medium includes a non-transitory computer-readable medium. An example of a computer-readable medium includes a magnetic recording medium (for example, a floppy disk, magnetic tape, or a hard disk drive), a magneto-optical recording medium (for example, a magneto-optical disk), a CD-ROM (read-only memory), CD-R, CD-R/W, and a semiconductor memory (for example, a mask ROM, a programmable ROM (PROM), an erasable PROM (EPROM), a flash ROM, or a random-access memory (RAM)).

Each embodiment described above is a suitable embodiment of the present invention, but the scope of the present invention is not limited to only the embodiments described above, and the present invention can be worked in forms resulting from making various modifications within a range that does not deviate from the substance of the present invention.

A post-processor, machining program generation method, CNC machining system, and machining program generation program according to the present disclosure can have various embodiments, which have configurations such as the following, including the embodiments described above.

(1) A post-processor, including: a machining command input unit (for example, the machining command input unit 304) that receives input of a machining command that is independent of a type of machine; a CNC information acquisition unit (for example, the CNC information acquisition unit 301) that communicates with a CNC device and acquires option information regarding the CNC device or information pertaining to a specification for the CNC device; a machining target input unit (for example, the machining target input unit 303) that receives input of machining-target information pertaining to a machining target; an available function determination unit (for example, the available function determination unit 302) that determines, based on the option information regarding the CNC device or the information pertaining to the specification for the CNC device acquired by the CNC information acquisition unit, a function available for machining; a machining program generation unit (for example, the machining program generation unit 305) that, based on the machining command, generates at least one machining program that uses, or does not use, at least one function determined to be available by the available function determination unit; a machining simulation unit (for example, the machining simulation unit 306) that simulates a machining result based on the at least one machining program generated by the machining program generation unit; a machining simulation result evaluation unit (for example, the machining simulation result evaluation unit 307) that, in accordance with the machining target, evaluates a machining simulation result outputted from the machining simulation unit; and a machining program output unit (for example, the machining program output unit 308) that, based on an evaluation regarding the machining simulation result, selects and outputs a machining program to be used in machining.

By virtue of this post-processor, it is possible for the post-processor to reference information regarding a CNC device and thereby generate a machining program by selecting a usage function based on the information regarding the CNC device. It is also possible for the post-processor to predict a machining result in a machining simulator and thereby output a machining program optimal for a machining target.

(2) The post-processor according to (1), in which the CNC information acquisition unit acquires parameter information regarding the CNC device, and the machining program generation unit generates the machining program that includes a command for changing one or more values for parameters for the CNC device that are included in the parameter information for the CNC device.

By virtue of this post-processor, it is possible to change operation by a machine partway through a program.

(3) The post-processor according to (1), in which the CNC information acquisition unit acquires parameter information regarding the CNC device, the machining simulation unit performs machining simulation under a plurality of conditions in which one or more parameters for the CNC device included in the parameter information for the CNC device are different, and based on the evaluation for the machining simulation result, the machining program output unit selects a machining program to use in machining, and outputs the machining program after inserting, into the machining program, a command for changing one or more parameter values for the CNC device.

By virtue of this post-processor, it is possible to change operation by a machine partway through a program.

(4) The post-processor according to (1), in which the CNC information acquisition unit acquires parameter information regarding the CNC device, the machining simulation unit performs machining simulation under a plurality of conditions in which one or more parameters for the CNC device included in the parameter information for the CNC device are different, and the post-processor includes a CNC parameter information output unit (for example, the CNC parameter information output unit 309) that, based on the evaluation for the machining simulation result, outputs CNC parameter information that includes a group of a number for one or more parameters for the CNC device and values for the parameters.

By virtue of this post-processor, in a case of changing a machine setting, it is sufficient if only parameter information for the CNC device is corrected, and there ceases to be a need to correct each program.

(5) The post-processor according to one of (1) to (4), including a target shape information input unit that receives input of post-machining target shape information, in which the machining simulation result evaluation unit evaluates the machining simulation result based on the machining simulation result and the target shape information.

(6) The post-processor according to one of (1) to (5), in which the machining command input unit receives input of a machining command in which machining is expressed as a set of one or more machining steps, the machining target input unit receives input of a different machining target for each machining step, and the machining program generation unit generates a machining program for each machining step.

(7) The post-processor according to one of (1) to (6), in which the post-processor is incorporated in the CNC device.

(8) The post-processor according to one of (1) to (7), including: a material shape information input unit configured to receive input of information regarding a material shape before machining, or a tool shape information input unit configured to receive input of information regarding a tool shape for a tool to be used in machining, in which the machining simulation unit uses the information regarding the material shape before machining or the information regarding the tool shape to perform the machining simulation.

(9) A CNC machining system provided with: the post-processor according to any one of (1) to (6); and a CNC machine (for example, the CNC machine tool 40) that has a CNC device connected to the post-processor and, based on a machining program outputted from the post-processor, performs CNC machining of a workpiece.

By virtue of this CNC machining system, it is possible for the post-processor to reference information regarding a CNC device and thereby generate a machining program by selecting a usage function based on the information regarding the CNC device. It is also possible for the post-processor to predict a machining result in a machining simulator and thereby output a machining program optimal for a machining target.

(10) A machining program generation method for a post-processor, the method including: receiving input of a machining command that is independent of a type of machine; communicating with a CNC device and acquiring option information regarding the CNC device or information pertaining to a specification for the CNC device; receiving input of machining-target information pertaining to a machining target; determining, based on the acquired option information regarding the CNC device or the information pertaining to the specification for the CNC device, a function that is available for machining; based on the machining command, generating at least one machining program that uses, or does not use, at least one function determined to be available; performing a machining simulation for a machining result based on a generated machining program; evaluating a result of the machining simulation in accordance with the machining target; and based on an evaluation regarding the machining simulation result, selecting and outputting a machining program to be used in machining.

By virtue of this machining program generation method, it is possible for the post-processor to reference information regarding a CNC device and thereby generate a machining program by selecting a usage function based on the information regarding the CNC device. It is also possible for the post-processor to predict a machining result in a machining simulator and thereby output a machining program optimal for a machining target.

(11) A machining program generation program for causing a computer that corresponds to a post-processor to execute: processing for communicating with a CNC device and acquiring option information regarding the CNC device or information pertaining to a specification for the CNC device; processing for determining, based on the acquired option information regarding the CNC device or the information pertaining to the specification for the CNC device, a function that is available for machining; processing for, based on a machining command that is independent of a type of machine, generating at least one machining program that uses, or does not use, at least one function determined to be available; processing for performing a machining simulation for a machining result based on a generated machining program; processing for evaluating a result of the machining simulation in accordance with an inputted machining target; and processing for, based on an evaluation regarding the machining simulation result, selecting and outputting a machining program to be used in machining.

By virtue of this machining program generating method, it is possible for the post-processor to reference information regarding a CNC device and thereby generate a machining program by selecting a usage function based on the information regarding the CNC device. It is also possible for the post-processor to predict a machining result in a machining simulator and thereby output a machining program optimal for a machining target.

### EXPLANATION OF REFERENCE NUMERALS

10 CAD device
20 Main processor
30, 30A Post-processor
40 CNC machine tool
301 CNC information acquisition unit
302 Available function determination unit
303 Machining target input unit
304 Machining command input unit
305 Machining program generation unit
306 Machining simulation
307 Machining simulation result evaluation unit
308 Machining program output unit
309 CNC parameter information output unit
310 External storage device
311 Target shape information input unit
312 Material shape information input unit
313 Tool shape information input unit
410 CNC device
411 Program analysis unit
412 Command output unit
413 Storage unit
420 Motor control device
421 Spindle-axis motor control unit
422 Feed-axis motor control unit
431 Spindle-axis motor
432 Feed-axis motor

1. A post-processor, comprising:
a machining command input unit configured to receive input of a machining command that is independent of a type of machine;
a CNC information acquisition unit configured to communicate with a CNC device and acquire option information regarding the CNC device or information pertaining to a specification for the CNC device;
a machining target input unit configured to receive input of machining-target information pertaining to a machining target;
an available function determination unit configured to determine, based on the option information regarding the CNC device or the information pertaining to the specification for the CNC device acquired by the CNC information acquisition unit, a function available for machining;
a machining program generation unit configured to, based on the machining command, generate at least one machining program that uses, or does not use, at least one function determined to be available by the available function determination unit;
a machining simulation unit configured to simulate a machining result based on the at least one machining program generated by the machining program generation unit;
a machining simulation result evaluation unit configured to, in accordance with the machining target, evaluate a machining simulation result outputted from the machining simulation unit; and
a machining program output unit configured to, based on an evaluation regarding the machining simulation result, select and output a machining program to be used in machining.

2. The post-processor according to claim 1, wherein
the CNC information acquisition unit acquires parameter information regarding the CNC device, and
the machining program generation unit generates the machining program that includes a command for changing one or more values for parameters for the CNC device that are included in the parameter information for the CNC device.

3. The post-processor according to claim 1, wherein
the CNC information acquisition unit acquires parameter information regarding the CNC device,
the machining simulation unit performs machining simulation under a plurality of conditions in which one or more parameters for the CNC device included in the parameter information for the CNC device are different, and
based on the evaluation for the machining simulation result, the machining program output unit selects a machining program to use in machining, and outputs the machining program after inserting, into the machining program, a command for changing one or more parameter values for the CNC device.

4. The post-processor according to claim 1, wherein
the CNC information acquisition unit acquires parameter information regarding the CNC device,
the machining simulation unit performs machining simulation under a plurality of conditions in which one or more parameters for the CNC device included in the parameter information for the CNC device are different, and
the post-processor further comprises a CNC parameter information output unit configured to, based on the evaluation for the machining simulation result, output CNC parameter information that includes a group of a number for one or more parameters for the CNC device and values for the parameters.

5. The post-processor according to claim 1, further comprising:
a target shape information input unit configured to receive input of post-machining target shape information,
wherein the machining simulation result evaluation unit evaluates the machining simulation result based on the machining simulation result and the post-machining target shape information.

6. The post-processor according to claim 1, wherein
the machining command input unit receives input of a machining command in which machining is expressed as a set of one or more machining steps,
the machining target input unit receives input of a different machining target for each machining step, and
the machining program generation unit generates a machining program for each machining step.

7. The post-processor according to claim 1, wherein the post-processor is incorporated in the CNC device.

8. The post-processor according to claim 1, further comprising:
a material shape information input unit configured to receive input of information regarding a material shape before machining, or a tool shape information input unit configured to receive input of information regarding a tool shape for a tool to be used in machining,
wherein the machining simulation unit uses the information regarding the material shape before machining or the information regarding the tool shape to perform the machining simulation.

9. A CNC system, comprising:
the post-processor according to claim 1; and
a CNC machine that has a CNC device connected to the post-processor and, based on a machining program outputted from the post-processor, performs CNC machining of a workpiece.

10. A machining program generation method for a post-processor, the method comprising:
receiving input of a machining command that is independent of a type of machine;
communicating with a CNC device and acquiring option information regarding the CNC device or information pertaining to a specification for the CNC device;
receiving input of machining-target information pertaining to a machining target;
determining, based on the acquired option information regarding the CNC device or the information pertaining to the specification for the CNC device, a function that is available for machining;
based on the machining command, generating at least one machining program that uses, or does not use, at least one function determined to be available;
performing a machining simulation for a machining result based on the at least one machining program generated;
evaluating a result of the machining simulation in accordance with the machining target; and
based on an evaluation regarding the machining simulation result, selecting and outputting a machining program to be used in machining.

11. A machining program generation program for causing a computer that corresponds to a post-processor to execute:
processing for communicating with a CNC device and acquiring option information regarding the CNC device or information pertaining to a specification for the CNC device;
processing for determining, based on the acquired option information regarding the CNC device or the information pertaining to the specification for the CNC device, a function that is available for machining;
processing for, based on a machining command that is independent of a type of machine, generating at least one machining program that uses, or does not use, at least one function determined to be available;
processing for performing a machining simulation for a machining result based on the at least one machining program generated;
processing for evaluating a result of the machining simulation in accordance with an inputted machining target; and
processing for, based on an evaluation regarding the machining simulation result, selecting and outputting a machining program to be used in machining.
